(19) United States
(12) Patent Application Publication
(10) Pub. No.: US 2018/0092708 A1
(43) Pub. Date: Apr. 5, 2018

(54) OPTICAL TOOL RECOGNITION SYSTEM FOR DENTAL DEVICES

(71) Applicant: Kerr Corporation, Orange, CA (US)

(72) Inventors: Sorin Cora, Orange, CA (US); Matteo R. Bosisio, Lugano (CH); Emanuele Maretto, Placentia, CA (US); Robert Thomas St. Louis, Charlotte, NC (US); Daniel Khalili, San Juan Capistrano, CA (US)

(21) Appl. No.: 15/721,791

(22) Filed: Sep. 30, 2017

Related U.S. Application Data
(60) Provisional application No. 62/402,082, filed on Sep. 30, 2016.

(51) Int. Cl. A61C 1/00; A61C 3/02; A61C 1/08

(52) U.S. Cl. CPC A61C 1/0015; A61C 1/02; A61C 1/08; A61C 3/02

(57) ABSTRACT

A tool recognition system includes a tool and a dental drill. The tool includes a fluted portion and a shank portion. The tool has one or more colored identifiers at least partially circumscribing a part of the shank portion. The dental drill includes a tool rotating portion, a light transmitter located in the tool rotating portion, and a light sensor. With the tool removably coupled to the tool rotating portion, the one or more colors present a sequence of one or more colors to the light sensor for identifying the tool to the light sensor when the tool rotates a predetermined number of turns. The dental drill includes a handpiece and a console in another embodiment.

### CROSS REFERENCE TO RELATED APPLICATIONS

This application claims the benefit of U.S. Provisional Patent Application No. 62/402,082 filed Sep. 30, 2016, the entire contents of which are hereby incorporated by reference.

### FIELD OF TECHNOLOGY

Embodiments relate generally to dental, orthodontic and/or surgical devices. More specifically, the disclosure relates to a tool recognition system for dental, orthodontic and/or surgical devices.

Endodontic therapy, inclusive of root canal therapy, entails a series of treatments performed on a tooth. The treatments are generally performed on structures within the tooth. Objectives of root canal therapy may typically include creating a conical form of the root canal, from an access cavity (coronal) to an apical foramen, preserving the natural curvature of the root canal, avoiding foramen transportation, and keeping the foramen as small as practical.

In endodontic therapy, a rotary file (referred to hereinafter as a “file”) coupled to a contra-angle piece of an endodontic rotary device is typically used. (“Rotary” in this context may include reciprocation, with a file spinning and/or reciprocating, and other motion types such as adaptive motion.)

A practitioner may insert a file, or a series of files, into the endodontic drill during a dental procedure. Each file type may require a specific set of motions to deliver the file's optimal performance. Several considerations that contribute to the determination of an appropriate set of motions for a file type may include canal curvature, calcification, specifics of a planned sequence of therapies to be applied, file size, file material, and file design considerations such as file cross-section, taper, flute file helix angle, rake angle and pitch.

Presently, endodontic drills have several predefined types of motions. Dental health practitioners must manually select an appropriate setting, such as speed and adaptive motion or reciprocating motion as a function of the type and size of each file they intend to use in a root canal procedure, and a maximum torque. If an incorrect motion parameter is set, the file may break inside the tooth, resulting in complications in the endodontic procedure. Furthermore, within the same procedure, different file sizes and types may be used in succession. Practitioner time may be wasted when the practitioner manually sets and resets endodontic drill motion parameters. Human error and lost time involved in manually calibrating the endodontic drill may contribute to sub-optimal clinical practice.

It would be desirable, therefore, to provide apparatus and methods for a reliable and automatic operational parameters or settings for, or calibration of, an endodontric drill.

The disadvantages of current endodontic drills discussed above apply to orthodontic, dental and surgical handpieces, which receive different tools, each tool being associated with unique handpiece settings.

It would be desirable, therefore, to provide apparatus and methods for a reliable and automatic calibration of orthodontic, dental and surgical handpieces to save time, reduce human error, and optimize tool performance.

### SUMMARY

Among other things, embodiments provide apparatuses and methods for electronically calibrating an orthodontic, dental or surgical handpiece to the unique settings of a tool removably coupled to the handpiece. The calibration may be effected by scanning or receiving information included on the tool or on the packaging of the tool. In one embodiment, the information is optically scanned.

In one embodiment, a tool recognition system comprises: a tool and a dental drill. The tool includes a fluted portion and a shank portion having one or more colored identifiers at least partially circumscribing a part of the shank portion. The dental drill includes a tool rotating portion, a light transmitter located in the tool rotating portion, and a light sensor. With the tool removably coupled to the tool rotating portion, the one or more colors present a sequence of one or more colors to the light sensor, thereby identifying the tool to the light sensor when the tool rotates a predetermined number of turns.

In another embodiment, a tool designed for performing portions of a root canal procedure includes a fluted portion, a shank portion, and one or more colored identifiers. Each of the one or more colored identifiers is disposed, at least partially, around at least a part of the shank portion. The one or more colored identifiers present a sequence of one or more colors to a light sensor that identify the tool when the tool rotates a specified number of times.

In another embodiment, a dental drill comprises a handle portion and a tool rotating portion. At least one of the handle portion and the tool rotating portion includes a color light sensor for identifying one or more colored identifiers located on a dental tool. The one or more colored identifiers are presented to a light sensor for identifying the dental tool.

In another embodiment, a dental drill comprises a handle portion, a tool rotating portion that is joined to the handle portion and a code scanner housed in one of the handle portion and the tool rotating portion. The code scanner is configured to capture one or more codes associated with a dental tool.

Other aspects and embodiments will become apparent by consideration of the detailed description and accompanying drawings.

### BRIEF DESCRIPTION OF THE DRAWINGS

FIG. 1 is a schematic representation of an embodiment of an apparatus including a handpiece;

FIG. 2 is an exploded partial cross-sectional view of the handpiece shown in FIG. 1;

FIG. 3 is a block diagram representation of an embodiment of the apparatus shown in FIG. 1;

FIG. 4 is a perspective view of a dental drill that includes a light sensor;

FIG. 5 is a perspective view of another embodiment of a dental drill that includes a light pipe;

FIG. 6 is a flow chart for operation of a handpiece or drill; and

FIG. 7 is a perspective view of an embodiment of a dental drill having a code scanner, and packaging provided with tools.

### DETAILED DESCRIPTION

Before any embodiments are explained in detail, it is to be understood that the these embodiments are not limited in their application to the details of construction and the arrangement of components set forth in the following description or illustrated in the following drawings. Other embodiments are possible and embodiments described are capable of being practiced or of being carried out in various ways.

Among other things, apparatuses and methods for calibrating a handset to the unique settings of a tool removably coupled to the handset are provided. The calibration may include scanning or receiving data stored on the tool or on a packaging of the tool. The apparatus may be used to perform one or more steps of the methods. The methods may include methods for manufacture of one or more of the apparatuses.

Exemplary embodiments are shown and described below. Features, including structures, materials, volumes, functions and other attributes that are shown and described in connection with any of the embodiments may be combined, in whole or in part, with each other or included, in whole or in part, in other embodiments.

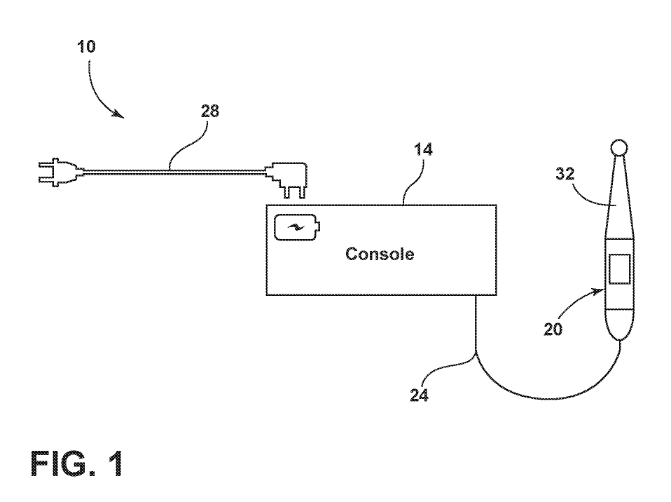

FIG. 1 shows an illustrative dental arrangement 10 that includes a console 14 in electronic communication with a handpiece 20. The handpiece 20 is typically connected at one end to the console 14 by a power connector 24. The console 14 is connected by a power cord 28 to a power outlet. Alternatively and/or additionally, the handpiece 20 may communicate wirelessly with the console 14. The handpiece 20 may be battery-powered in one embodiment. The handpiece 20 includes a contra-angle section 32 at another end to receive a tool. In one embodiment, a tool (not shown) is a replaceable, spinable file. Over the course of a dental procedure, such as endodontic therapy or a prophylaxis, a series of files (not shown) may be used.

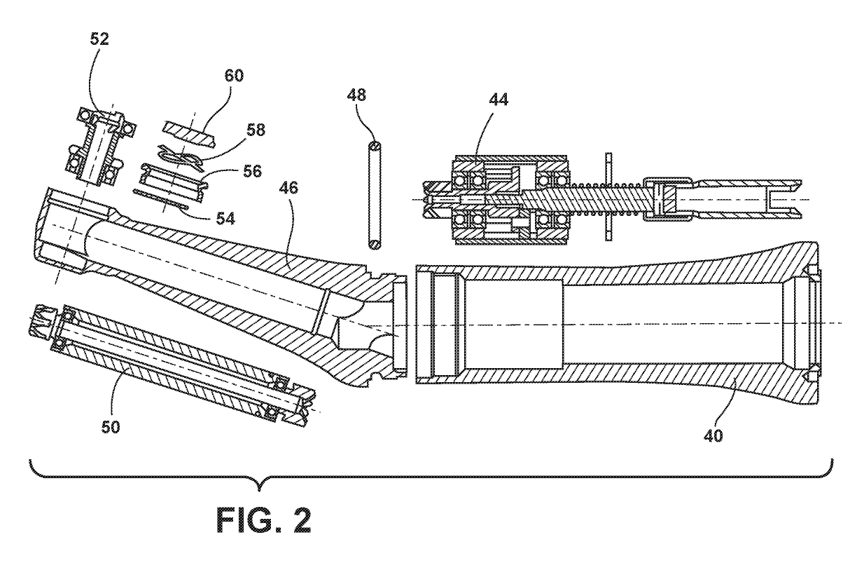

FIG. 2 shows an illustrative lateral cross-sectional exploded view of a contra-angle handpiece 20. The handpiece 20 includes a screw sleeve 40, a gearbox assembly 44, a spring washer, a head sleeve 46, an O-ring 48, an intermediate piece assembly 50, a head gear assembly 52, a washer 54, a cover 56, a wave spring 58 and a button 60.

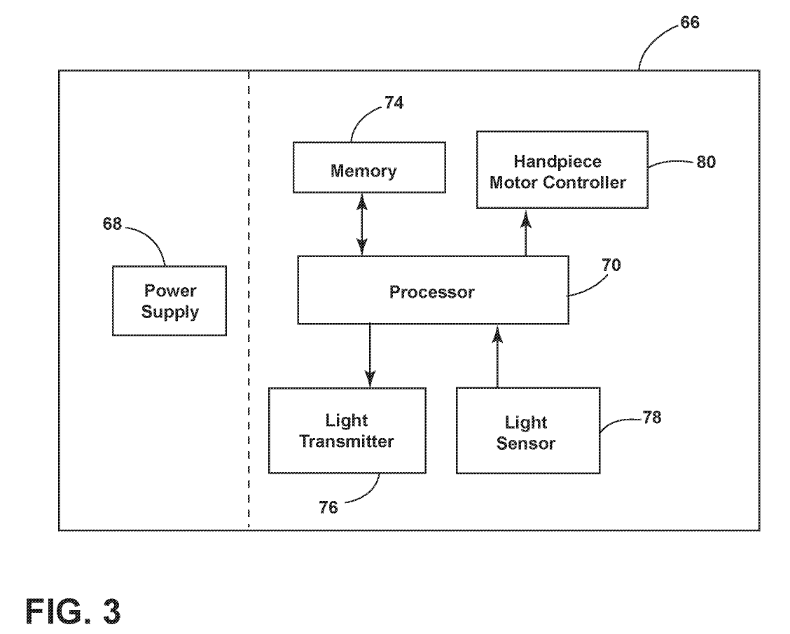

FIG. 3 shows a block diagram 66 of one embodiment of the dental arrangement 10 shown in FIGS. 1 and 2. The block diagram 66 includes a power supply 68 to provide power to the various components including an electronic processor 70 and a memory 74. Further, the electronic processor 70 provides control signals to a light transmitter 76 and receives input signals from a light sensor 78. The diagram includes a handpiece motor controller 80 that is controlled by the electronic processor 70. The handpiece motor controller controls movement and thus turns of a tool driven by a handpiece motor.

In some embodiments, the electronic processor 70 is a microprocessor, an application-specific integrated circuit (“ASIC”), or other suitable electronic processing device having a memory 74. In some embodiments, the memory 74 is a non-transitory computer-readable medium including random access memory (“RAM”), read-only memory (“ROM”), or other suitable non-transitory computer-readable medium. Other types of memory 74 and circuitry are contemplated.

In one embodiment, the power supply 68 is located in the console 14 and the other components shown in FIG. 3 are disposed in the handpiece 20. Other arrangements are contemplated, wherein the light transmitter 76, the light sensor 78 and the memory 74 are disposed in the console 14. In another embodiment, the electronic processor 70 is also disposed in the console 14.

In one embodiment, the light transmitter 76, such as a Red/Green/Blue (RGB) light emitting diode (LED), is disposed in the head sleeve 46 to apply light toward a tool affixed thereto. In one embodiment, the light sensor 78 is a Red/Green/Blue (RGB) light sensor disposed in or on the head sleeve 46 to receive light reflected from the tool.

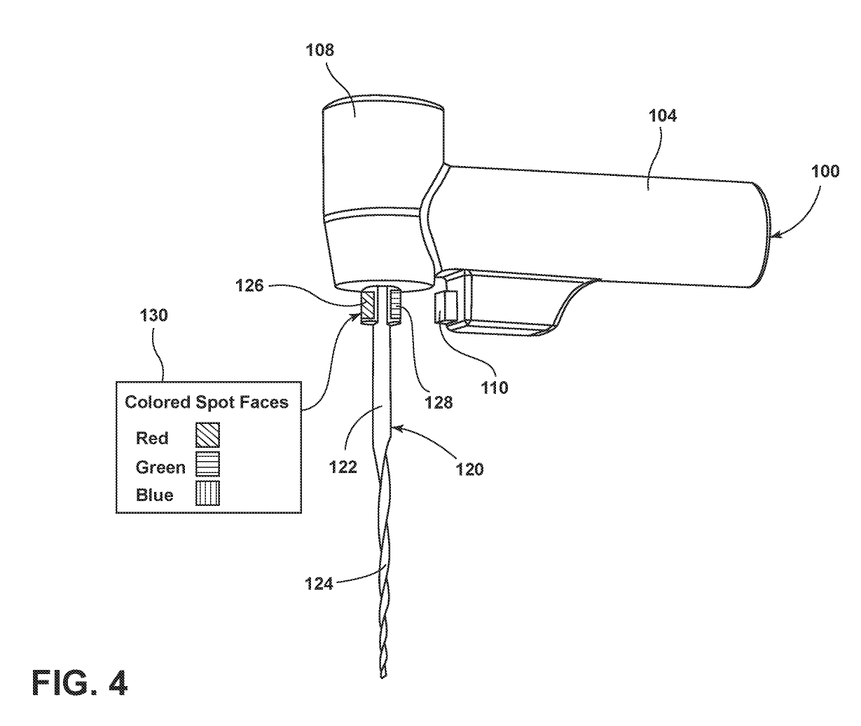

FIG. 4 shows a dental drill 100 that includes a handle portion 104 and a cylindrical tool rotating portion 108. The dental drill 100 includes an RGB light sensor 110. An opening or receiving port at an end of the cylindrical tool rotating portion 108 is configured to receive a tool 120. The tool includes a shank portion 122 and a fluted portion 124 at a distal end. The tool 120 includes colored identifiers on the shank portion 122 thereof. The code identifiers include a red code identifier 126 and a green code identifier 128. A table 130 in FIG. 4 shows indicia for representing red, green and blue color identifiers.

In one embodiment, each of the one or more colored identifiers wrap, at least partially, around at least a part of the shank portion 122. The one or more colored identifiers 126, 128 are painted, or otherwise affixed, around at least a part of the shank portion 122 of the tool 120. The one or more colored identifiers may be fixedly attached to, or integral with the shank portion 122 of the tool 120. Thus, the colored identifiers at least partially circumscribe a part of the shank portion 122 about a circumference thereof.

Each of the one or more colored identifiers may present one or more colors to the light sensor 110. In one embodiment, two or more colored identifiers 126, 128, in combination and in sequence, are sensed to identify the tool 120. Thus, two or more colored identifiers present a sequence of two or more colors to the light sensor. In another embodiment, four colored identifiers are spaced about the circumference of the shank portion 122 of the tool 120.

The dental drill 100 includes an electronic processor, a memory, and other components as illustrated in FIG. 3. In one embodiment, all of the components shown in FIG. 3 are disposed within the dental drill 100. In another embodiment, a light transmitter 76 is not provided as natural light provides enough light for the light sensor 78.

The dental drill 100 shown in FIG. 4 receives a tool 120 that is removably coupled thereto. Exemplary tools include burs, stones, wheels, discs, files, ultrasound tips, and any other suitable instrument or device. The dental drill 100 is used in orthodontic, dental or surgical procedures. The handpiece 20 shown in FIG. 1 receives similar exemplary tools and is used in orthodontic, dental or surgical procedures. The procedures include a prophylaxis procedure and/or an endodontic procedure

The dental drill 100 shown in FIG. 4 receives a tool 120 that is removably coupled thereto. Exemplary tools include burs, stones, wheels, discs, files, ultrasound tips, and other instruments. The dental drill 100 is used in orthodontic, dental or surgical procedures. In one embodiment, the dental drill 100 is an endodentic drill. The handpiece 20 shown in FIG. 1 receives similar exemplary tools and is used in orthodontic, dental or surgical procedures. The procedures include a prophylaxis procedure and/or an endodontic procedure.

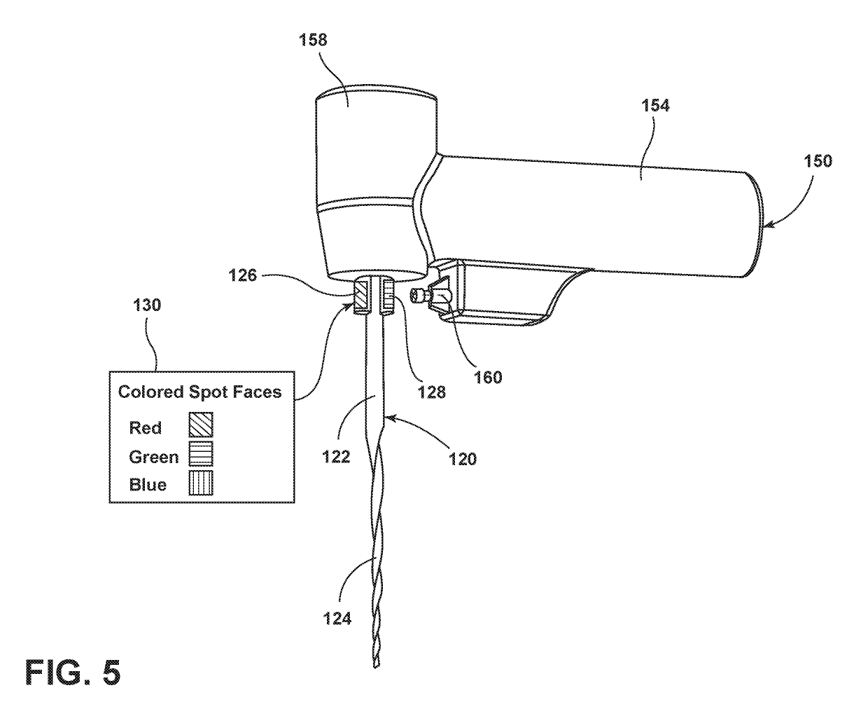

FIG. 5 shows an illustrative dental drill 150 that includes a handle portion 154 and a cylindrical tool rotating portion 158. The dental drill 150 includes an optic light pipe 160. An opening at an end of the tool rotating portion 158 is configured to receive a tool 120 as shown in FIG. 4. The tool 120 includes a shank portion 122, a fluted portion 124, a red code identifier 126 and a green code identifier 128. In one embodiment, the dental drill 150 is an endodontic drill.

The optic light pipe 160 shown in FIG. 5 provides the colored identifiers 126, 128 received from the shank portion 122 to a light sensor 78 that is disposed within the dental drill 150 or within a console 14 in another embodiment. The information/color read by the dental drill 150 is used to calibrate the endodontic drill to specific parameters for the tool 120.

Operation

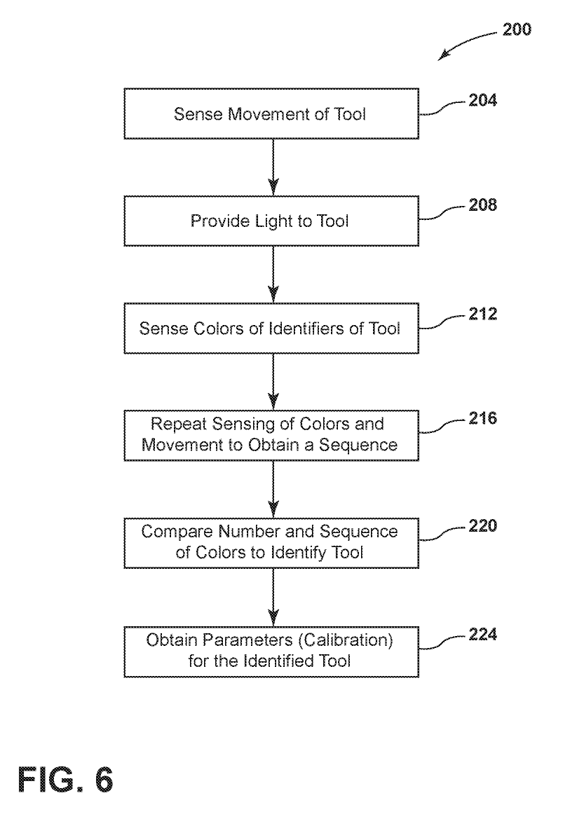

More specifically, as shown in the flow chart 200 of FIG. 6, the dental arrangement 10 provides a tool recognition system for sensing rotation of the tool 120 by the handpiece 20. More specifically, the electronic processor 70 executes the steps shown in FIG. 6 as follows.

The electronic processor 70 senses rotation of the tool (step 204). In response to rotation, the electronic processor 70 controls the light transmitter 76 or a light source, to provide light toward the tool (step 208).

The light sensor 78 senses unique colors red/green/blue of identifiers disposed at a shank portion 122 of the tool 120, which is provided to the electronic processor (step 212). The electronic processor 70 repeats the sensing of colors and sensing rotation of the tool to obtain a number of color identifiers and a sequence of one or more colors corresponding to a rotation of the tool 120 (step 216). In one embodiment, the tool rotates a specified number of times or a predetermined number of turns to enable sensing of sequence information by the light sensor 78 and the electronic processor 70.

The electronic processor 70 compares the number and sequence of colors with stored number and sequences of colors stored in a memory to identify the tool 120 disposed on the handpiece 20 (step 220). Upon identifying the specific tool 120, the electronic processor 70 obtains or loads calibration and/or use data and other parameters for the identified tool 120 (step 224). The parameters include properties of the tool and may include type of motion for operating the tool, along with torque values for the identified tool.

Thereafter, operation of the handpiece 20 is conducted so that the proper motion is provided for the operating tool, and maximum torque values for the identified tool are not exceeded. Thus, the handpiece 20 operates the identified tool 120 specifically as intended. For instance, the type of rotation or movement of the tool may differ depending on the identification.

While the above flow chart 200 was discussed with respect to the handpiece 20 and console 14 shown in FIG. 1, the same operation applies to the embodiments of a dental drill 100, 150 as shown in FIGS. 4 and 5.

Code Scanning

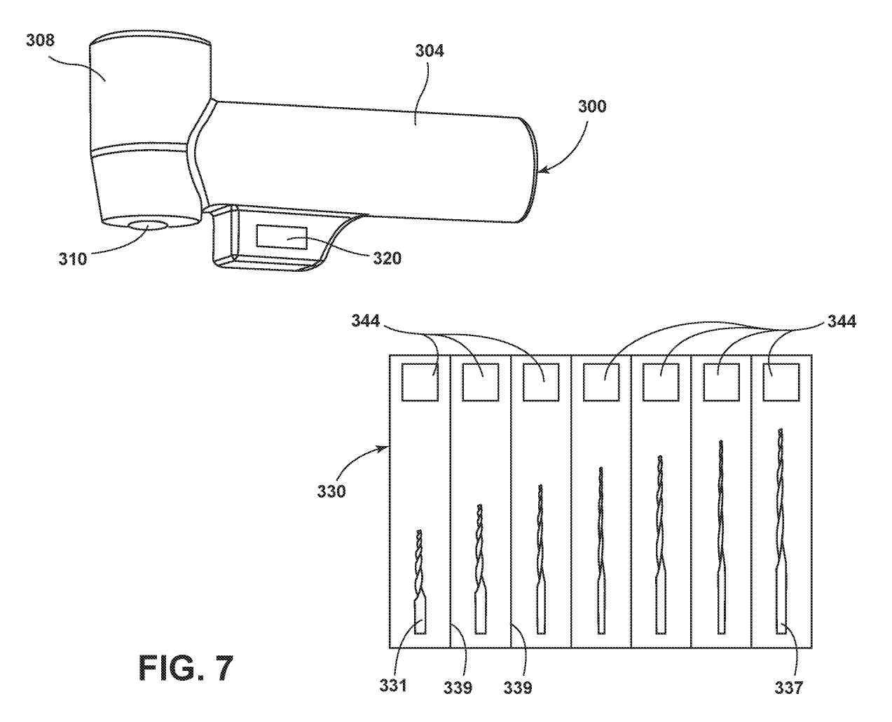

FIG. 7 shows an illustrative apparatus in accordance with another embodiment. A dental drill 300 includes a handle portion 304 and a cylindrical tool rotating portion 308 having an opening 310 for receiving a tool. Further, the dental drill 300 includes a code scanner 320 disposed near the handle portion 304. Further, FIG. 7 shows a packaging 330 that houses a plurality of tools 331, 337. The packaging 330 encloses each tool in a separate section of the packaging defined by perforations 340. Each section of the packaging 330 that encloses a dental tool includes a code 344.

While the codes 344 are represented as boxes, the codes 344 each include a unique indicia corresponding the specific unique sized tool 331,337. In one embodiment, the one or more codes 344 are one or more two-dimensional bar codes. In another embodiment, the one or more codes 344 are one or more three-dimensional bar codes. In another embodiment, the one or more codes 344 are quick response (QR) codes. QR codes typically include small squares arranged in various patterns.

The dental drill 300 shown in FIG. 7 includes an electronic processor, a memory and other components as illustrated in FIG. 3, except the drill detects codes, rather than color.

In operation, a user places the code 344 for the selected tool 331, 337 adjacent the code scanner 320. The code scanner 320 is configured to scan the code 344. In one embodiment the code scanner 320 is a bar code scanner. The scanned information is provided to an electronic processor. The electronic processor compares the scanned code from the packaging with stored codes provided in a memory disposed in the drill 300 or a console connected thereto. Then, the electronic processor is configured to match the scanned code with one of the stored codes, and obtain a plurality of drill parameters from a memory that correspond to the scanned code for an identified tool. The electronic processor then executes software to control the dental drill 300 to operate at the drill parameters received from the memory. The drill parameters correspond to tool parameters for the identified tool. Thus, the electronic processor of the drill 300 uses the scanned information to calibrate the drill to tool-specific parameters.

### Alternative Embodiments

In one embodiment, the dental tool 120 is an endodontic tool. In another embodiment, the dental tool 120 is an endodontic file, and the packing of the endodontic file is packaging that contains the endodontic file therein.

In some embodiments, a tool, such as a file, is inserted into an endodontic drill. The file may be snapped into the endodontic drill. In some embodiments, the endodontic drill includes the file. The apparatus and methods may include a series of files.

In one embodiment, the method includes attaching the file to the endodontic drill. The method may include assembling the file with the endodontic drill. The method may include inserting the file into the endodontic drill.

In one embodiment, the endodontic drill includes a light sensor and a light transmitter. The light sensor is a color light sensor, such as a red-blue-green (“RGB”) color light sensor. The light transmitter is an optic light pipe, such as an optic fiber light pipe.

Light bouncing off of the one or more colored identifiers on the file may present one or more colors to the light sensor. Thus, the arrangement is configured for presenting a sequence of the one or more colored identifiers, when the file turns, to identify the file to the endodontic drill.

In one embodiment, the tool rotating portion of the endodontic drill includes fiber optic cables (and terminals of those cables) or an optic light pipe for transmitting light from one or more colored identifiers located on an endodontic file to the color light sensor located in the handle portion of the endodontic drill. The color light sensor included on the endodontic drill may identify one or more colored identifiers located on an endodontic file. In some embodiments, the light reflected off the one or more colored identifiers, and subsequently received by the light sensor, is used by the endodontic drill to identify the file.

The drill may include one or more memories. The one or more memories may associate data received by the light sensor with a tool-identifier. The memories may also associate each tool-identifier with endodontic drill calibration data.

The one or more memories may be embedded in an endodontic drill. In some embodiments, the console may include the one or more memories. The one or more memories may be embedded in the console.

The one or more memories may include one or more look-up tables. The look-up table(s) may be updated. The look-up tables may be look-up tables of one or more file-identifiers. The one or more memories may store data associating each file-identifier with endodontic drill calibration data such as usage conditions, motion parameters, file usage conditions and/or file usage parameters.

In another embodiment, when a light sensor receives light reflected off of a file, the light sensor transmits data identifying characteristics of the light received to the one or more memories. The one or more memories may retrieve a look-up table to identify a tool-identifier associated with received light characteristic data. The one or more memories then access endodontic drill calibration or operating parameter data associated with the retrieved tool-identifier. The one or more memories may subsequently provide the operating parameters for the endodontic drill based on the accessed calibration data for the specific tool. The calibration data may include settings for operating speed, adaptive motion or reciprocating motion for the tool, and a maximum torque for the tool.

In some embodiments, the one or more memories store results of measuring and/or calculating one or more tool variables. The variable(s) may relate to a tool or a file and/or endodontic drill performance, such as a number of times that the tool or file turned, the RPM, when the tool or file last received sterilization, how much oil the endodontic drill needs, or any other suitable type of performance data. The variable(s) may also relate to one or more of endurance, durability, errors, error-rates, useful/safe life left in the tool or file, data related to tool or file expiry, and to other properties of the tool(s).

The apparatus may include hardware external to the endodontic drill. For example, in some embodiments, the apparatus may include a console as shown in FIG. 1. The console may be in electronic communication with the endodontic drill. The electronic communication may be effected by hardware such as a wire, or by a wireless connection such as a blue-tooth connection.

In some embodiments, the console may download data from the one or more memories of the endodontic drill. Exemplary data may include usage condition(s), usage parameter(s), variable(s), tool identifier(s), or any other relevant data. In some embodiments, the endodontic drill may download data from the console, such as usage condition(s), usage parameter(s), variable(s), tool identifier(s), or any other relevant data.

The endodontic drill may perform data acquisition, data recording, data storage and/or data processing independent of the console. The endodontic drill may perform data acquisition, data recording, data storage, data transmission and/or data processing in conjunction with the console.

The console may be connected to the internet for updates. The endodontic drill may be connected to the internet for updates.

In some embodiments, the endodontic drill and/or the console may include a code scanner. In some of these embodiments, the file may include one or more codes and/or packaging associated with the file may include one or more codes. The code scanner may be configured to capture the code(s) located on the file and/or the file packaging. The codes may include information identifying the file and, in some embodiments, endodontic drill calibration data.

In some embodiments, a practitioner may scan the codes located on the file or the packaging of the file using the scanner included in the console or the handpiece either before or after inserting the file into the endodontic drill. In some embodiments, the codes may be scanned by the scanner when the file is still in its packaging.

In some of these embodiments, endodontic drill calibration data may be stored in the code. In these embodiments, scanning the code may upload the endodontic drill calibration data into the endodontic drill and, in response thereto, calibrate the drill by setting the endodontic drill to the settings included in the calibration data, which are appropriate for the endodontic drill.

In some embodiments, the one or more codes may include a tool-identifier. The tool-identifier may be stored in the one or more memories of the endodontic drill. In some of these embodiments, scanning the one or more codes with the code scanner may prompt computer apparatus located in the endodontic drill or console to access a look-up table and retrieve endodontic drill settings associated with the tool-identifier. After retrieving the endodontic drill settings, the endodontic drill may calibrate itself accordingly.

Apparatus and methods described herein are illustrative. The steps of the disclosed methods may be performed in an order other than the order shown and/or described herein. Some embodiments may omit steps shown and/or described in connection with the illustrative methods. Some embodiments may include steps that are neither shown nor described in connection with the illustrative methods. Illustrative method steps may be combined. For example, one illustrative method may include steps shown in connection with another illustrative method.

Some apparatus may omit features shown and/or described in connection with illustrative apparatus. Some embodiments may include features that are neither shown nor described in connection with the illustrative methods.

Features of illustrative apparatus may be combined. For example, one illustrative embodiment may include features shown in connection with another illustrative embodiment.

Apparatus may involve some or all of the features of the illustrative apparatus and/or some or all of the steps of the illustrative methods. Methods may involve some or all of the features of the illustrative methods and/or some or all of the steps of the illustrative apparatus.

The code scanner may be configured to scan the code. The endodontic drill may use the scanned information to calibrate the endodontic drill to file-specific parameters.

For illustrative purposes, an endodontic drill and a tool are disclosed as illustrative embodiments of a handpiece and tool. These examples are for illustrative purposes only and do not limit the scope of the invention in any way. It will be understood that features of an “endodontic drill” described herein can be applied to any orthodontic, dental or surgical handpiece. It will also be understood that any features of a “tool” described herein can be applied to an orthodontic, dental or surgical tool that is removably coupled to a handpiece. All combinations of the aforementioned embodiments are contemplated.

Thus, embodiments provide, among other things, a tool recognition system having a dental device that senses color or a visual code on the tool or tool packaging. The handpiece or drill then powers or drives the tool in accordance with the corresponding parameters for the specific tool. Various features and advantages are set forth in the following claims.

What is claimed is:

1. A tool recognition system comprising:
a tool including a fluted portion and a shank portion;
one or more colored identifiers, each of the one or more colored identifiers at least partially on the shank portion; and
a dental drill comprising a tool rotating portion, a light transmitter located in the tool rotating portion, and a light sensor,
wherein when the tool is removably coupled to the tool rotating portion, the one or more colors present a sequence of one or more colors to the light sensor, thereby identifying the tool when the tool rotates a specified number of turns.

2. The tool of claim 1 wherein the tool is an endodontic file.

3. A tool for performing a root canal procedure, the tool comprising:
a fluted portion;
a shank portion; and
one or more colored identifiers, each of the one or more colored identifiers on, at least partially, at least a part of the shank portion, the one or more colored identifiers for presenting a sequence of one or more colors to a light sensor, the one or more colored identifiers sensed by the light sensor are provided to an electronic processor that identifies the tool when the tool rotates a specified number of times.

4. The tool of claim 3 wherein the light sensor is an RGB light sensor and the one or more colored identifiers includes two or more colored identifiers for presenting a sequence of two or more colors to the light sensor.

5. The tool of claim 3 wherein the light sensor includes an optic light pipe.

6. The tool of claim 3 wherein the tool is an endodontic file.

7. A dental drill comprising:
a handle portion; and
a tool rotating portion;
wherein the handle portion or the tool rotating portion includes a color light sensor for identifying one or more colored identifiers located on a dental tool, the one or more colored identifiers for presenting one or more colors to a light sensor, and the one or more colored identifiers for identifying the dental tool.

8. The dental drill of claim 7 wherein the color light sensor comprises an RGB light sensor.

9. The dental drill of claim 7 wherein the color light sensor comprises an optic light pipe.

10. The dental drill of claim 7 wherein the tool is an endodontic file.

11. The dental drill of claim 7 wherein the color light sensor is configured to identify the one or more colored identifiers, wherein each of the one or more colored identifiers wrap, at least partially, around at least a part of a shank portion of the dental tool.

12. A dental drill comprising:
a handle portion;
a tool rotating portion, joined to the handle portion;
a code scanner;
wherein the handle portion or the tool rotating portion houses the code scanner, the code scanner configured to capture one or more codes associated with a dental tool.

13. The dental drill of claim 12 wherein the one or more codes comprises a two-dimensional bar code.

14. The dental drill of claim 12 wherein the one or more codes comprises a three-dimensional bar code.

15. The dental drill of claim 12 wherein the one or more codes comprises a QR code.

16. The dental drill of claim 12, the dental drill including an electronic processor and a memory,
wherein the code scanner is configured to scan a code disposed on packaging of a dental tool;
wherein the processor is configured to
receive the code from the code scanner,
compare the code from the code scanner with stored codes in the memory,
match the code with one of the stored codes to identify the dental tool,
obtain a plurality of drill parameters for the dental tool, and
set the drill parameters for operation by the dental drill based on the obtained plurality of drill parameters.

17. The dental drill of claim 16, wherein the memory is disposed in the endodontic drill.

18. The dental drill of claim 16, wherein the dental drill includes a console and a handpiece, and the memory is disposed in the console.

19. The dental drill of claim 12, wherein the dental tool is an endodontic file.
